(19) United States
(12) Patent Application Publication
(10) Pub. No.: US 2026/0097569 A1
(43) Pub. Date: Apr. 9, 2026

(54) Container Crusher

(71) Applicant: YETI Coolers, LLC, Austin, TX (US)

(72) Inventors: Derek G. Sullivan, Austin, TX (US); George N. Popa, III, Lakeway, TX (US); Steve Charles Nichols, Austin, TX (US)

(21) Appl. No.: 18/910,139

(22) Filed: Oct. 9, 2024

(51) Int. Cl. B30B 1/06; B02C 1/10; B30B 9/00; B30B 15/06

(52) U.S. Cl. CPC B30B 1/06; B02C 1/10; B30B 9/00; B30B 15/062

(57) ABSTRACT

Container crushers are described. The container crushers may include an input crank, one or more guide shafts, and a crusher plate connected to a frame. The container crusher may be configured to receive a container. The container crusher may be further configured such that input to the crank moves the crusher plate downward along the one or more guide shafts, for example, to crush a container. The crusher plate may include one or more ribs configured to engage the container and to hold the container in the crusher during operation. The container crusher may further include a latch system. The latch system may include an annular resilient detent plunger and a detent catch configured to deform and receive the resilient detent plunger to retain the crank and the crusher plate in a raised position.

### FIELD

The present disclosure relates generally to crusher devices, and in particular beverage container crushers.

### BACKGROUND

Beverages are often stored in containers, for example, cans. Following beverage consumption, the container is emptied of its contents but may retain its space-taking shape. It may be desirable to reduce the size of the emptied container.

### SUMMARY

This Summary introduces a selection of concepts relating to this technology in a simplified form as a prelude to the Detailed Description that follows. This Summary is not intended to identify key or essential features.

One or more example aspects of the present disclosure relate to devices comprising crushers, for example, beverage container (e.g., vessel) crushers. The container crusher may include a frame. The frame may be configured to be fixed to a surface. The frame may include a guide shaft. The container crusher may further include a crank. The crank may be connected to the frame and may be configured to move, about a pivot, upon receipt of an input force. The container crusher may further include a plate (e.g., a crusher plate) connected to the crank. The plate may be connected to the crank via a link such that rotation of the crank causes the plate to move linearly along the guide shaft. The container crusher may further include an annular resilient detent plunger. The annular resilient detent plunger may be disposed in an annular recess of the guide shaft. The container crusher may further include a bushing. The bushing may be engaged with the plate and the guide shaft. The bushing may include an annular detent catch. The annular detent catch may be configured to engage the detent plunger to retain the crank and plate in a raised position.

In one or more additional or alternative example aspects of the present disclosure, the annular detent plunger may be formed of a material comprising thermoplastic polyurethane (TPU), thermoplastic elastomers (TPE), or silicone. Additionally or alternatively, the annular detent plunger may include an annular protrusion configured to protrude from a surface of the guide shaft. The annular protrusion may include a first sloped surface and a second sloped surface. The first sloped surface and the second sloped surface may have different angles of inclination. Additionally or alternatively, the annular protrusion may be disposed at an outer surface of the annular resilient detent plunger. The annular resilient detent plunger may further include an annular arcuate recess at an inner surface thereof substantially opposed to the annular protrusion.

In one or more additional or alternative example aspects of the present disclosure, detent catch of the container crusher may further include a notch. The notch may be configured to engage the annular protrusion to retain the crank and plate in an initial (e.g., raised) position. Additionally or alternatively, the bushing of the container crusher may further include a first sloped surface and a second sloped surface. The first sloped surface and the second sloped surface may each be configured to engage and deform the annular resilient detent plunger.

In one or more additional or alternative example aspects of the present disclosure the plate may include a hole. Additionally, the bushing, in an outer surface thereof, may include a recess. The hole and the recess may be configured to receive a screw, through the hole and into the recess, to retain the engagement of the bushing with the plate.

In one or more additional or alternative example aspects of the present disclosure, the frame of the container crusher may further include a platform. The platform may be disposed substantially opposite the plate such that rotation of the crank may cause the plate to move linearly toward the platform.

In one or more additional or alternative example aspects of the present disclosure, the plate, for example, on an underside thereof, may include one or more ribs or tines. The one or more ribs or tines may be configured to engage an edge or a rim of a container upon linear movement of the plate. Additionally or alternatively, the one or more ribs or tines may be inclined downward as the one or more ribs or tines extend toward a front of the plate. Additionally or alternatively, the one or more ribs or tines may be configured to hold a container in the container crusher during operation.

In one or more additional or alternative example aspects of the present disclosure, the crusher device may further include an annular resilient bumper stop. The annular resilient bumper stop may be disposed at an end of the guide shaft. The annular resilient bumper stop may be configured to engage the plate toward an end of movement of the plate.

These and additional features will be appreciated with the benefit of the disclosures discussed in further detail below.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1 depicts an example crusher device.

FIG. 2 depicts a rear view of an example crusher device.

FIG. 3 depicts an example crusher device in the context of use.

FIG. 4 depicts an alternate view of an example crusher device.

FIG. 5A depicts a cross-sectional view of an example crusher device and magnified section C.

FIG. 5B depicts a further magnified portion of section C of FIG. 5A.

Further, it is to be understood that the drawings may represent the scale of different components of various examples; however, the disclosed examples are not limited to that particular scale. Further, the drawings should not be interpreted as requiring a certain scale unless otherwise stated.

### DETAILED DESCRIPTION

In the following description of the various examples and components of this disclosure, reference is made to the accompanying drawings, which form a part hereof, and in which are shown by way of illustration various example structures and environments in which aspects of the disclosure may be practiced. It is to be understood that other structures and environments may be utilized and that structural and functional modifications may be made from the specifically described structures and methods without departing from the scope of the present disclosure.

Also, while the terms “front,” “top,” “base,” “bottom,” and “side” and the like may be used in this specification to describe various example features and elements, these terms are used herein as a matter of convenience, e.g., based on the example orientations shown in the figures and/or the orientations in typical use. Nothing in this specification should be construed as requiring a specific three-dimensional or spatial orientation of structures in order to fall within the scope of the claims.

In the description that follows, reference is made to one or more crusher devices. The crusher devices may be used, for example, to crush (e.g., deform) beverage containers, for example, empty beverage cans. Empty (and uncrushed) beverage cans may occupy the same space as a full beverage can. However, in the case of an empty beverage can, this space-taking shape may be undesirable. Space is often at a premium. Thus, it may be advantageous to crush empty beverage containers, for example, to conserve space.

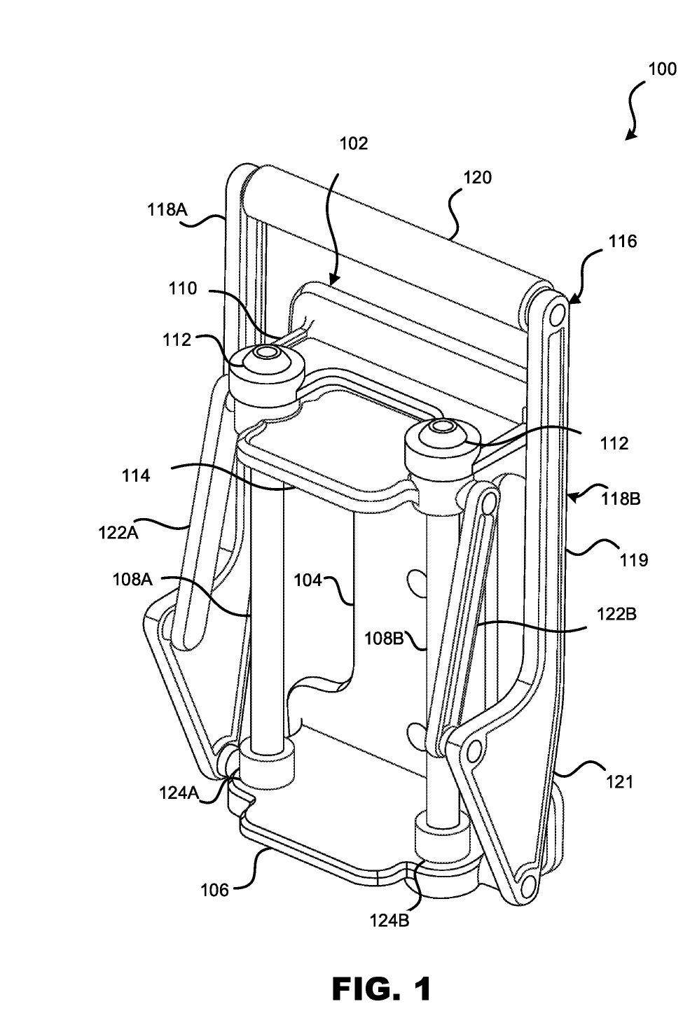

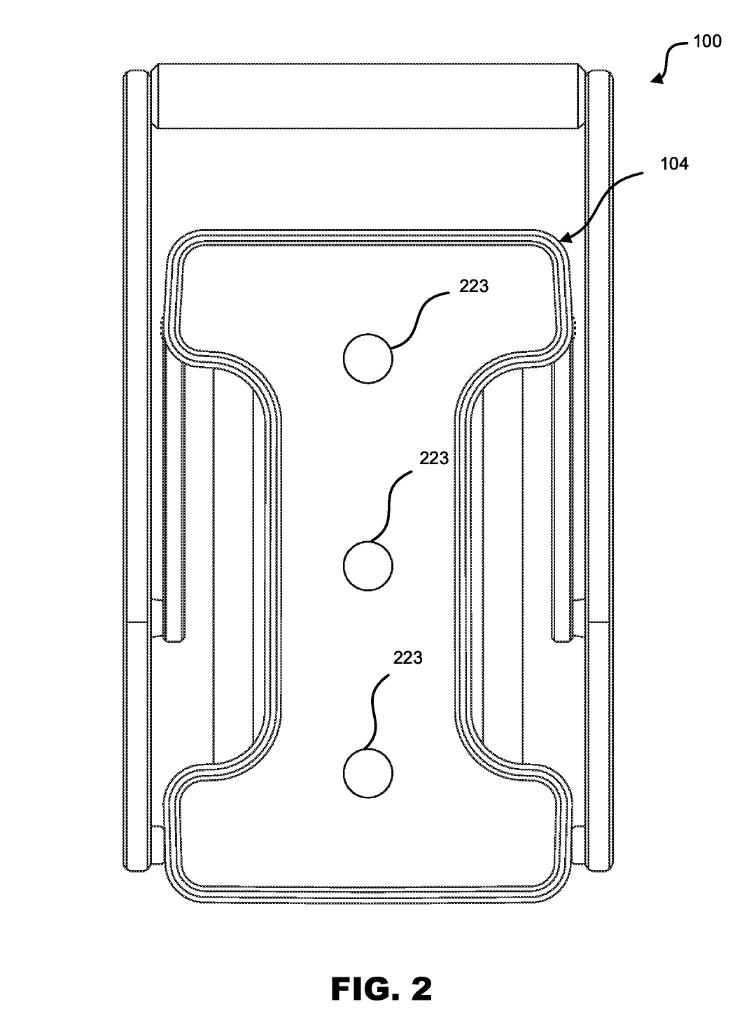

FIG. 1 depicts an example crusher device 100. The crusher device 100 may comprise a frame 102. The frame 102 may be configured to mount to a surface (e.g., a wall, door, etc.). The frame 102 may comprise a fixed part, for example, to which additional parts may be mated. Additional parts may be fixedly or movably (e.g., rotatably, slidably) mated to the frame 102 (e.g., as described herein). The frame 102 may comprise a rear (e.g., posterior) plate 104. The rear plate 104 may be configured to mount to a surface (e.g., as described herein). The rear plate 104 may be substantially vertically oriented and may be configured to be mounted to a substantially vertical surface.

The frame 102 may further comprise a bottom plate 106 (e.g., inferior plate). The bottom plate 106 may comprise a bottom (e.g., lower) crusher plate. The bottom plate 106 may comprise a platform. The bottom plate 106 may extend forwardly (e.g., anteriorly) from a portion (e.g., an inferior portion) of the frame 102. The bottom plate 106 may be fixedly mated to the rear plate 104. Alternatively, the bottom plate 106 may be hingedly and/or rotatably mated to the rear plate 104. For example, the bottom plate 106 may be hingedly mated to the frame 102 such that the bottom plate 106 may rotate downward (e.g., following a crushing operation), for example, to dump the crushed container out of the crusher device 100. The bottom plate 106 may be configured to engage, receive, and/or hold a beverage container (e.g., drinkware, vessel, etc.) (e.g., empty tin can) during operation.

The crusher device 100 may comprise one or more guides, for example, first shaft 108A and second shaft 108B (generally, shaft(s) 108). The shafts 108 may comprise guide rails or guide shafts (e.g., linear guide shafts). The example configuration of FIG. 1 depicts shafts 108, other example configurations may include otherwise configured guides. For example, one or more of shafts 108 may be replaced with profile rail guides. The shafts 108 may be connected to (e.g., fixedly mated to) the frame 102. The shafts 108 may be arranged and/or disposed substantially vertically. The shafts 108 may be connected, at a first end thereof, to the bottom plate 106. The shafts 108 may extend substantially vertically and upward (e.g., superiorly) from the bottom plate 106. The shafts 108 may be connected (e.g., fixedly mated to), at a second end thereof, to a second portion of the frame 102. The shafts may be connected, at the second end thereof, to one or more superior extensions 110, for example, extending forwardly from the rear plate 104. In this manner, the shafts 108, or other guides, may be connected in a substantially vertical manner between an upper portion of the frame 102 and a lower portion of the frame 102.

The shafts 108 may be variously mated with the frame 102. For example, connectors 112 may be used to connect the shafts 108 to the frame 102. For example, connectors 112 may be threaded. Threaded connectors 112 may be passed or threaded into holes in the frame 102 and into correspondingly threaded receptacles in the shafts 108. Additionally or alternatively, one or more ends of the shafts 108 themselves may be threaded into correspondingly threaded mating features of the frame 102. Additionally or alternatively, the frame 102 (e.g., at the bottom plate 106 and/or at the superior extension 110) may be slotted (e.g., etched, routed, etc.). The shafts 108 may be slid into the corresponding slots. The shaft 108 may be fixed in the slots (e.g., with set screws, adhesives, etc.). Although the shafts 108 are described as being mated to the frame 102, in other example configurations, the shafts may be unitary with (e.g., a part of) the frame 102.

The crusher device 100 may further comprise a crusher plate 114. The crusher plate 114 may be disposed above (e.g., superior to and/or substantially opposite) the bottom plate 106. The crusher plate 114 may be slidably mated to the shafts 108 (or otherwise configured guides) and/or the frame 102. For example, the crusher plate 114 may be configured to move linearly along the shafts 108. The crusher plate 114 may be slidably mated with the shafts 108 such that the crusher plate 114 can be moved (e.g., slid) toward and away from the bottom plate 106. Additional features of the crusher plate 114 are described herein in additional detail.

The crusher device 100 may further comprise a crank 116. The crank 116 may comprise a handle, handle assembly, or crank assembly. The crank 116 may comprise a first crank link 118A and a second crank link 118B (generally, crank link(s) 118). The crank 116 may further comprise a grip portion 120. The grip portion 120 may comprise an elongate feature extending between the first crank link 118A and the second crank link 118B. In the example configuration of a crank assembly, the grip portion 120 may be rotatably mated or fixedly mated to the crank links 118. Alternatively, the grip portion 120 may be formed unitarily with (e.g., as one piece) with the crank links 118. The grip portion 120 may be substantially cylindrical or otherwise shaped (e.g., rectangular cuboid). Each of the first and second crank links 118A and 118B may be rotatably mated (e.g., at a pivot point) to the frame 102. The crank links 118 may be rotatably mated to a portion of the frame 102 proximate to the bottom plate 106. Alternatively, the crank links 118 may be rotatably mated to other portions of the frame 102.

The crusher device 100 may further comprise one or more linkages, for example, first linkage 122A and second linkage 122B (generally, linkage(s) 122). Each linkage 122 may, at a first end, be rotatably mated to a crank link 118 and, at a second end, be rotatably mated to the crusher plate 114. For example, the first linkage 122A may, at a first end thereof, be rotatably mated to the first crank link 118A. The first linkage 122A may, at a second end thereof, be rotatably mated to the crusher plate 114 (e.g., at or proximate to a first side thereof). The second linkage 122B may, at a first end thereof, be rotatably mated to the second crank link 118B. The second linkage 122B may, at a second end thereof, be rotatably mated to the crusher plate 114 (e.g., at or proximate to a second side thereof, for example, substantially opposed to the first side of the crusher plate 114).

The crank links 118 may each comprise one or more rotation mates or pivot points. For example, the crank links may be pivotally mated at a first pivot point to the frame and pivotally mated at a second pivot point to an associated linkage 122. Additionally or alternatively, the crank links 118 may further comprise a third pivot point, at which the crank link 118 may be pivotally mated to the grip portion 120. The three pivot points may be disposed and/or distributed on the crank links 118 in a triangular shape. For example, considering the crank in a substantially upright or initial position, the third pivotal mate (e.g., with the grip potion 120) may be disposed at about an upper (e.g., superior) end of the crank links 118. Alternatively, a non-pivotal gripping portion may be mated with the crank links 118 at about the upper end thereof. The crank links 118 may extend downward (e.g., inferiorly) to a lower end. The first pivotal mate (e.g., between the crank link 118 and the frame 102) may be disposed at about the lower end. The first pivotal mate may be disposed inferior to the third pivotal mate. Additionally or alternatively, the first pivotal mate may be disposed forward (e.g., anterior) to the third pivotal mate. The second pivotal mate (e.g., between the crank link 118 and the linkage 122) may be disposed between the first and third pivotal mates. For example, second pivotal mate may be disposed inferior to the third pivotal mate and superior to the first pivotal mate. Additionally or alternatively, the second pivotal mate may be disposed anterior to the first and third pivotal mates.

To accommodate the pivot points, an example configuration of the crank links 118 may be shaped as follows. The crank links 118 may comprise a stem 119 (e.g., a column) and a foot 121 (e.g., a base). The stem 119 may extend downward (e.g., inferiorly) from an upper end of the crank link 118 toward the foot 121. The stem 119 may be comprise a substantially vertical extension. The stem 119 may terminate in the foot 121. The foot 121 may be substantially triangular shaped. A first side of the triangular shape may extend from the stem 119 anteriorly. The first side of the triangular shape may terminate about at the second pivot mate. A second side of the triangle may extend inferiorly and posteriorly from the second pivot mate to the first pivot mate. The third leg of the triangle may extend superiorly from the first pivotal mate and terminate at the stem 119. The third leg may additionally extend posteriorly from the first pivotal mate.

The crusher device 100 may further comprise one or more bump stops, for example, first bump stop 124A and second bump stop 124B (generally, bump stop(s) 124). The bump stops 124 may be disposed above and engage the bottom plate 106. The bump stops 124 may be configured to engage, for example, at an end of its range of motion, the crusher plate 114. For example, the bump stops may be configured to, upon contact with the moving crusher plate 114, absorb energy from the crusher plate 114. The bump stops 124 may be annularly shaped. The bump stops 124 may be disposed around a corresponding shaft 108. The bump stops 124 may be fabricated from one or more materials that offer increased energy absorption (e.g., over metal) and/or are, for example, durable and resist plastic deformation. Such materials may comprise, for example, rubber, polyurethane, thermoplastics, foam, elastomeric compounds, metal-rubber composites, plastics, polymers, high density polyethylene (HDPE), ethylene propylene diene monomers (EPDM), etc.

One or more features of the crusher device 100 may be constructed from various materials. For example, features of the crusher device, for example, the frame 102 the crusher plate 114, the crank 116, linkages 122, etc. may be constructed from, for example, metals and/or alloys, for example, steel, tinplate steel, stainless steel, aluminum, titanium, and/or tin and combinations thereof. For example, features of the crusher device 100 may be constructed from cast aluminum. Additionally or alternatively features of the crusher device 100 may be constructed from stamped steel. Features op the crusher 100 may be variously constructed, for example, features may be stamped, machined, cast, forged, welded, extruded, rolled, bent, etc. The present disclosure is not limited to such features and methods, and persons of ordinary skill in the art may appreciate other materials and method from which to fabricate features of the crusher device 100.

FIG. 2 depicts a rear view of an example crusher device 100. Referring to FIG. 2, the frame 102 of the crusher device 100 may be configured to be mounted to a surface (e.g., a wall). For example, the rear plate 104 may comprise one or more mounting points 223 configured for receiving fasteners (e.g., screws). In some examples, the rear plate 104 may be configured to mounted to a vertical or substantially vertical surface. The one or more mounting points 223 may comprise, for example, holes (e.g., screw holes) through the rear plate 104. Three inline mounting points 223 are depicted in FIG. 2. It should be appreciated that alternatively configured example crusher devices may have more or less mounting points 223, and the mounting points may be alternatively arranged (e.g., in a square configuration). In some example configurations, the three inline mounting points 223 may be configured to be positioned along a vertical line such that the crusher device 100 is in an upright vertical orientation. In some other example configurations, the three inline mounting points 223 may be positioned along a horizontal line, for example, such that the crusher device may be mounted and/or operated in a horizontal orientation. The rear plate 104 may be substantially “I” shaped. Alternatively, the rear plate 104 may be substantially parallelogram-shaped.

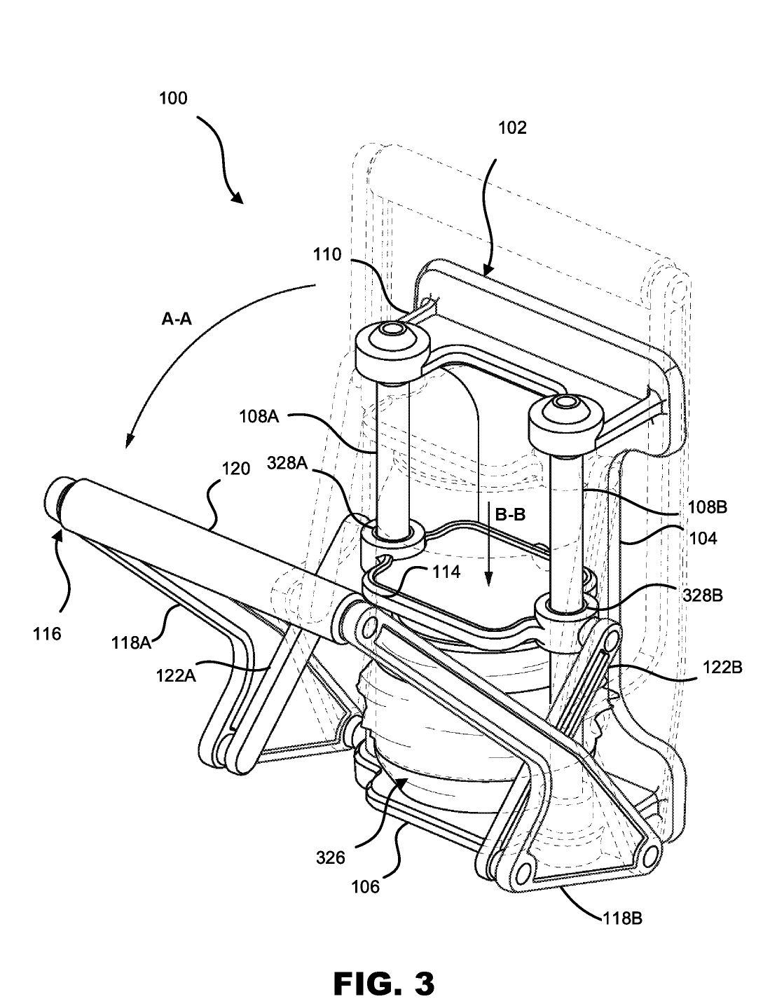

FIG. 3 depicts an example crusher device 100 in the context of use. In use, a beverage container 326 (e.g., empty beverage can, vessel, drinkware, etc.) may be placed between the bottom plate 106 and the crusher plate 114. A user may engage the crank 116 (e.g., at the grip portion 120) and apply an input force to (e.g., pull on) the crank 116. The user may rotate the crank 116 at its pivot point (e.g., rotational mate) with the frame 102. The crank 116 may be rotated in the direction of arrow A-A and rotate from a first position (e.g., starting, initial, or rest position) (depicted by dashed lines) to a second position. Input force applied to the crank 116 may be transmitted to the linkages 122 via the rotational mating points of the crank links 118 with the linkages 122. Input force may be transmitted through the linkages 122 to the crusher plate 114 (via the rotational mate point of the linkages 122 and the crusher plate 114) providing a downward force on the crusher plate 114 and moving the crusher plate 114 downward, as indicated by arrow B-B, toward the bottom plate 106. As described, the crusher plate 114 may be slidably mated with the shafts 108. For example, the crusher plate 114 may comprise one or more holes, for example, first hole 328A and second hole 328B (generally, hole(s) 328). Each hole 328 may be disposed around a corresponding shaft 108. The holes 328 may be configured to engage (e.g., slidably engage) a corresponding shaft 108. The holes 328 may be configured to prevent the crusher plate 114 from moving substantially laterally in relation to the shafts 108. With the downward movement of the crusher plate 114, the crusher plate 114 may engage the beverage container 326 (e.g., at a rim of the beverage container 326). The downward force of the crusher plate 114 may provide a crushing force (e.g., between the crusher plate 114 and the bottom plate 106) to the beverage container 326. With continued reference to FIG. 3, a continued input force to the crank (e.g., in the direction of arrow A-A) may continuously crush the beverage container 326 until the crusher plate 114 contacts the bump stops 124 (and, in some example configurations, compresses the bump stops 124 until the input force is overcome) and/or the force of the crushed beverage container 326 overcomes the input force.

It should be appreciated that the crusher device 100 may comprise a four-bar linkage, particularly a slider-crank or four-bar slider mechanism. The components of the mechanism may include, for example, the frame 102 (e.g., ground link), the crank 116 (e.g., input link), the linkages 122 ( e.g., coupler links), the crusher plate 114 (e.g., slider), and the shafts 108 (e.g., guides or tracks). It will be appreciated that the four-bar linkage mechanism of the crusher device 100 may provide a mechanical advantage. For example, the mechanism of the crusher device 100, substantially as described, may multiply the input force applied by a user, for example, to the crank 116, for example, as applied by the crusher device 100 to the beverage container 326. In some example configurations, the mechanism of the crusher device 100 may multiply the input force by a factor of about 2 to about 4. In some example configurations, the mechanism of the crusher device 100 may multiply the input force by a factor of about 3. Accordingly, the crusher device 100 may facilitate a mechanical advantage for crushing the beverage container 326.

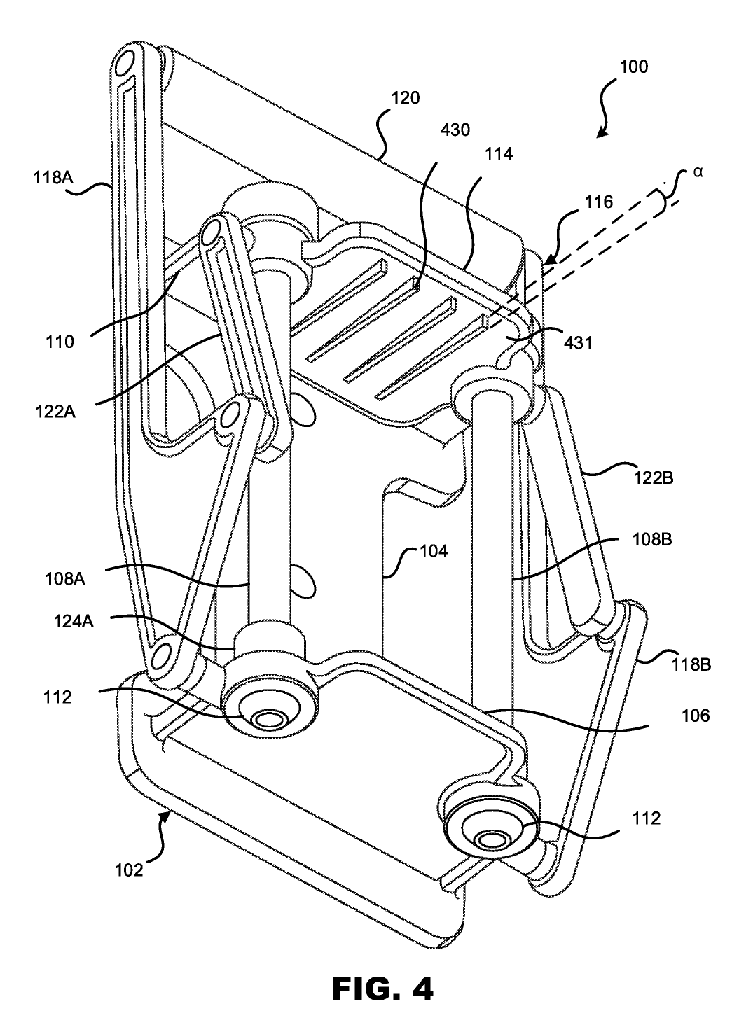

FIG. 4 depicts an alternate view of the crusher device 100. As described herein, in use, the crusher plate 114 may engage a rim of a beverage container (e.g., beverage container 326) during the crushing action. Without anything to retain the beverage container in the crusher device 100, the beverage container may tend to fall out of the device during use, for example, before crushing is complete. Referring to FIG. 4, the crusher plate 114 may comprise one or more container engagement ribs 430. The one or more container engagement ribs 430 may comprise tines. For clarity, only one of a plurality of container engagement ribs 430 is referenced with numeral “430” in FIG. 3. While FIG. 3 depicts four (e.g., a plurality of) container engagement ribs 430, it should be appreciated that other example configurations may comprise one or more container engagement ribs 430. The container engagement ribs 430 may be disposed on an underside (e.g., inferior side) of the crusher plate 114. The container engagement ribs 430 may be configured to engage a rim of a beverage container (e.g., beverage container 326 of FIG. 3). The container engagement ribs 430 may extend in a rearward-frontward (e.g., posterior-anterior) direction. The container engagement ribs 430 may comprise an angled (e.g., sloped, inclined etc.) surface. The surface may incline downward (e.g., in an inferior direction) as the container engagement ribs 430 extend from a rear end to a front end. The container engagement ribs 430 may comprise an angle of incline ‘α,’ from example, away from an underside surface 431 of the crusher plate 114. In some example configurations, the angle of incline ‘α’ may comprise about 5°. In some example configurations, the angle of incline ‘α’ may be in a range of about 4° to about 8°. In other example configurations, the angle of incline may be a different non-zero angle.

In use, the container engagement ribs 430 may engage a rim of a beverage container being crushed. As the crusher plate 114 is moved downward, the sloped and/or inclined surface of the container engagement ribs 430 may translate the downward force into a vertical, downward or inferior component and a lateral, posterior component. The downward component of the force may cause crushing of the beverage container. The lateral (e.g., posterior) component of the force may push and/or retain the beverage container in the device. For example, the lateral component of the force, exerted by the sloped surface of the container engagement ribs 430, may push the beverage container toward the rear plate 104 of the crusher device 100, thereby advantageously holding the beverage container in the crusher device 100 during use. In example configurations, the plurality of depicted container engagement ribs 430, may be replaced by a singular sloped rib and/or surface.

The sloped container engagement ribs 430 may provide additional advantages. For example, some beverage containers (e.g., drink cans) are designed for increased strength vertically (e.g., through an axis, for example, a center longitudinal axis, of the container) (e.g., to facilitate stacking). By configuring the container engagement ribs 430 to be sloped (e.g., angled), an interface with the beverage container may be created that is other than perpendicular to the axis of the beverage container. Additionally, the crushing force may be translated to the beverage container at an angle to the axis of the beverage container. This configuration may facilitate crushing of the beverage container with reduced input force. For example, the container engagement ribs 430 may be configured to create an interface between the crusher plate 114 and the rim of the container such the force applied is other than symmetrically about the center axis. For example, the container engagement ribs 430 may be configured to create an interface between the crusher plate 114 and the rim of the container such that a force is concentrated on one side of the rim of the container (e.g., as opposed to being substantially evenly distributed across the rim of the container). Such a configuration may reduce the force input to buckle the container.

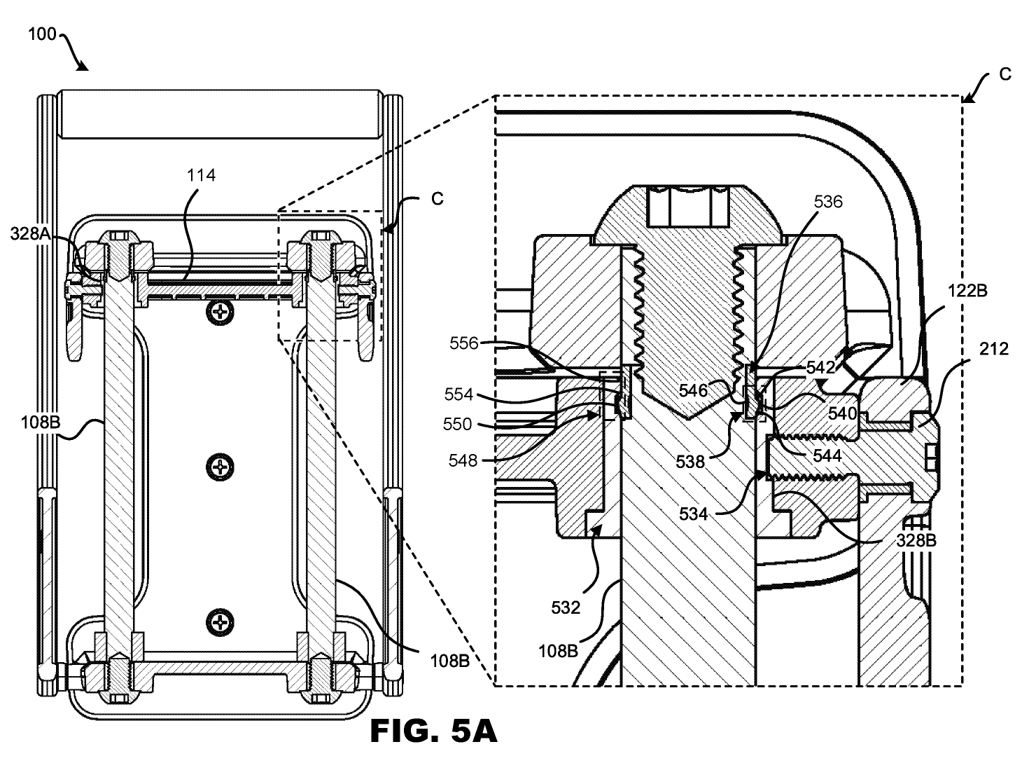

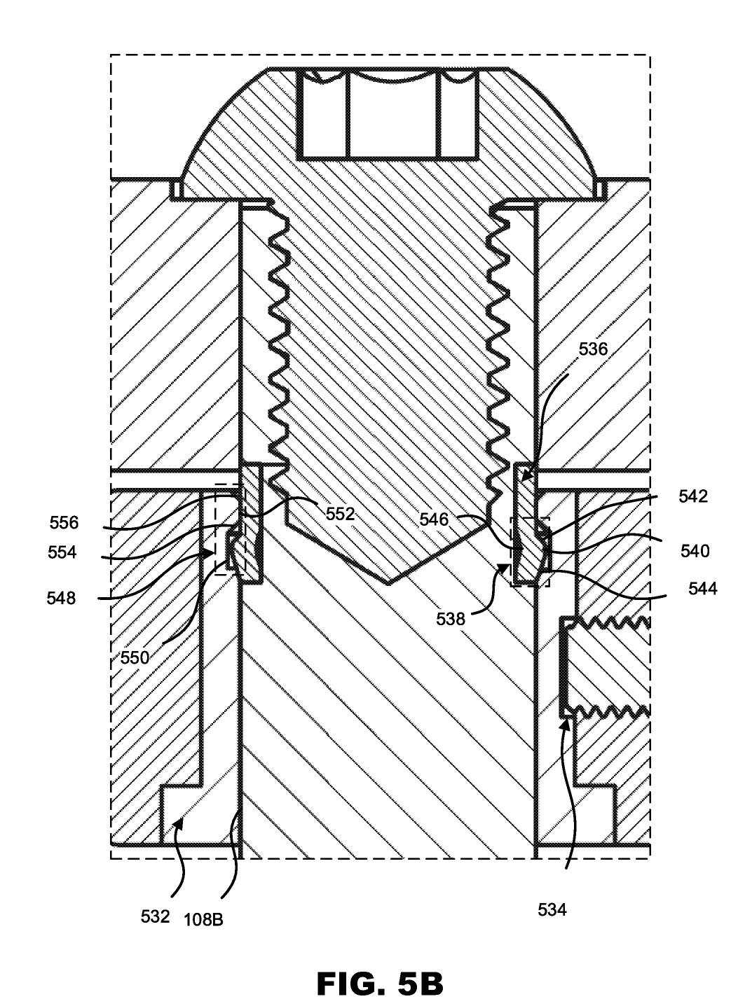

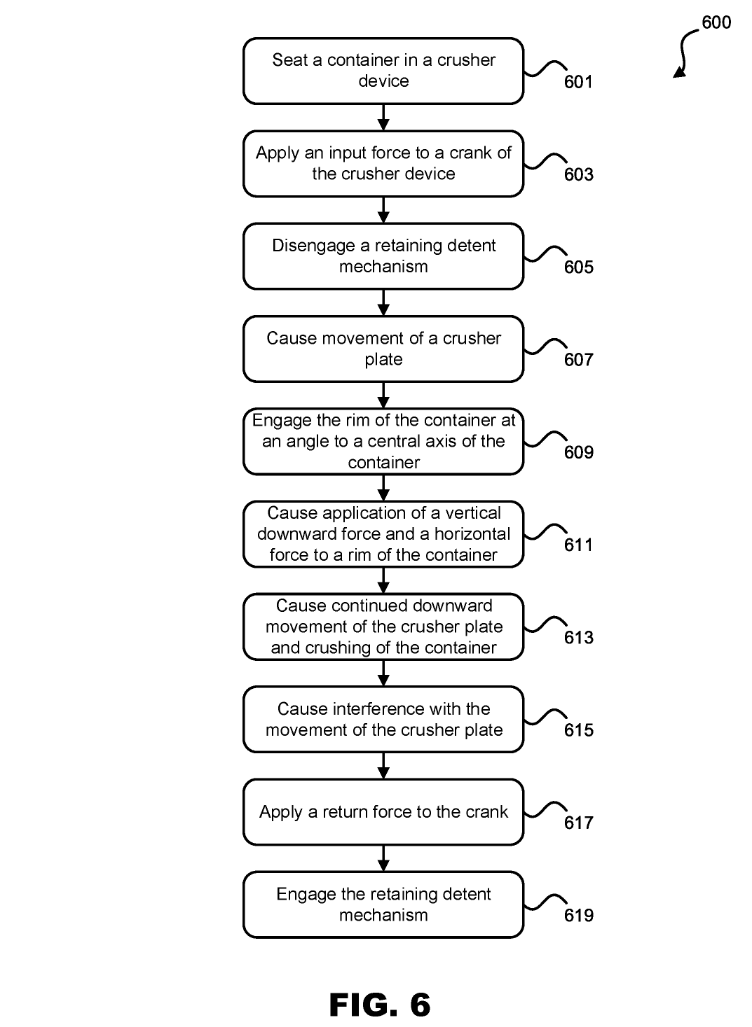

FIG. 5A depicts a cross-sectional view of an example crusher device 100 and magnified section C. FIG. 5B depicts a further magnified portion of section C of FIG. 5A. Referring to FIGS. 5A and 5B, and as described elsewhere herein, the crusher plate 114 may be slidably mated and/or engaged with the shafts 108, for example, via holes 328. For an improved and durable slidable mate between the crusher plate 114 and the shafts 108, bushings 532 may be disposed around a shaft and in the holes 328. The bushings 532 may comprise, for example, metallic bushings (e.g., bronze, brass, steel etc.), self-lubricating bushings (e.g., oil-impregnated, PTFE-lined, graphite-embedded, etc.), plastic and composite bushings (e.g., Delrin (e.g., acetal), nylon, polyethylene, fiberglass-reinforce, etc.) ceramic bushings, etc. The bushings 532 may slidably engage a corresponding shaft 108. The bushings 532 may comprise an exterior recess 534. The exterior recess 534 may comprise a recessed shape in the exterior surface of the bushing 532. The exterior recess 534 may be localized or annular (e.g., around the entire circumference of the bushing 532). The exterior recess 534 may receive a connector 212. The connector 212 may comprise a shoulder connector, for example, a shoulder screw. The connector 212 may extend through the linkage 122 (e.g., first linkage 122A), through a portion of the crusher plate 114 (e.g., a portion surrounding hole 328), and into the exterior recess 534. The connector may be rotatably mated with the linkage 122. It can be appreciated that input force (e.g., on the crank 116) may be transferred to the crusher plate 114 via the connectors 212 (and, e.g., linkages 122). Additionally, the connector extending into the exterior recess 534 may act to retain the bushing from sliding in relation to the crusher plate 114. Accordingly, the connector 212 may be configured to retain the bushing in the hole 328 in the crusher plate 114.

It may be appreciated that absent features retaining the crank 116 in its initial (e.g., substantially upright) position, the crank 116 may fall (e.g., to an end or intermediate position). For example, the crank 116 may fall due to the weight of the crusher plate 114. Alternatively, an input force (e.g., an unintentional input force) to the crank 116 may cause the crank to fall. The crank 116, in its fallen position, may cause an inconvenience. For example, an unsuspecting person walking by the fallen crank 116 may strike a limb (e.g., a knee) on the extended fallen crank 116. Additionally, when the crank 116 is in its end or intermediate position, a user may first need to lift the crank 116 before placing a beverage container between the crusher plate 114 and the bottom plate 160. Accordingly, it may be advantageous to include one or more retention features (e.g., latch features) and/or systems to retain the crank 116 substantially in its initial or starting (e.g., substantially vertical) position.

Referring to FIGS. 5A and 5B, and particularly to magnified section C, the crusher device 100 may comprise a latch or crank retention system (e.g., comprising one or more of bushing 532, annular detent 536, protrusion 540, first sloped surface 542, second sloped surface 544, scalloped region 546, detent catch 548, notch 550, pressing surface 552, first sloped catch surface 554, and second sloped catch surface 556). The latch system may retain the crank 116 and the crusher plate 114 in an initial (e.g., starting, ready, raised) position. For example, one or more of the shafts 108 (e.g., shaft 108B) may comprise an annular recess 534. The annular recess 534 may comprise an annular groove. The annular recess 534 may be formed around a circumference of the shaft 108. An annular detent 536 may be disposed in the annular recess 534. The annular recess 534 may be configured to receive and/or engage the annular detent 536. The annular detent 536 may be formed of a resilient material; for example, the annular detent 536 may comprise a resilient ring. The substantially resilient material may comprise a material that is substantially resilient to plastic deformation, for example, silicone, silicone rubber, ethylene-propylene diene monomer (EPDM), thermoplastic elastomer (TPE), polyurethane (PU), thermoplastic polyurethane (TPU), nitrile rubber (NBR), acrylic elastomer, butyl rubber (IIR), polyvinyl chloride (PVC), etc.

The annular detent 536 may comprise a detent plunger 538. The detent plunger 538 may be substantially resilient, for example, as described herein. The detent plunger 538 may be disposed in a detent plunger 538 region of the annular detent 536. The detent plunger 538 may comprise an annular protrusion 540 (e.g., projection). The detent plunger 538 may protrude from a surface (e.g., an exterior or outer surface) of the annular detent 536. The annular detent plunger 538 may further comprise a one or more sloped surfaces, for example, a first sloped surface 542 and a second sloped surface 544. The first sloped surface 542 and/or the second sloped surface 544 may incline out toward the protrusion 540. The first sloped surface 542 and/or the second sloped surface 544 may incline from about an exterior (e.g., outer) surface of the annular detent 536 toward the protrusion 540. Additionally or alternatively, the first sloped surface 542 and/or the second sloped surface 544 may initiate about flush with an exterior surface of the shaft 108 and incline outward toward and terminate at the protrusion 540. The first sloped surface 542 and the second sloped surface 544 may each comprise an angle of inclination. The angles of inclination of the first sloped surface 542 and the second sloped surface 544 may be the same or different. For example, the angle of inclination of the first sloped surface 542 may be substantially higher than the angle of inclination of the second sloped surface 544.

The annular detent 536 may further comprise a scalloped region 546 of the detent plunger 538. The scalloped region 546 may comprise a notch, indentation, cutout, groove, recess, or concavity in an inner surface of the annular detent 536. The scalloped region may comprise a substantially arcuate or otherwise rounded shape (e.g., in cross-section). The scalloped region 546 may be substantially opposed to the protrusion 540. The detent plunger 538 may be configured to at least partially deform (e.g., collapse) into the scalloped region 546, for example, upon a force exerted on one or more of the protrusions 540, the first sloped surface 542, and the second sloped surface 544. The detent plunger 538 may be configured such that the deformation may comprise an elastic deformation. The detent plunger 538 may be configured such that a force to the detent plunger 538 may deform the detent plunger 538 (e.g., the protrusion 540) radially inward (e.g., toward the axis of the annular detent 536).

With continued reference to FIGS. 5A and 5B, the latch system may further comprise the bushing 532. The bushing 532 may comprise a detent catch 548. The detent catch 548 may comprise a notch 550. The notch 550 may comprise an annular notch, recess, or grove in the bushing 532. The notch 550 may be notched from an inner surface of the bushing 532. The notch 550 may be configured to engage and/or receive the detent plunger 538, for example, the protrusion 540 of the detent plunger 538. The detent catch 548 may further comprise a pressing surface 552, a first sloped catch surface 554, and a second sloped catch surface 556. The pressing surface 552 may be configured to engage the first sloped surface 542 of the detent plunger 538, the second sloped surface 544 of the detent plunger 538, and the protrusion 540 of the detent plunger. The pressing surface may engage the detent plunger 538 and apply a force to one or more surfaces or features of the detent plunger 538 to deflect (e.g., deform, collapse) the detent plunger 538 (or a portion thereof) radially inward and into the scalloped region 546. The first sloped catch surface 554 and/or the second sloped catch surface may be configured to engage the first sloped surface 542 of the detent plunger 538 and/or the second sloped surface 544 of the detent plunger 538.

In use, and with continued reference to FIGS. 5A and 5B, an example configuration of the latch system may operate as follows. In its initial (e.g., starting) rest position (e.g., with the crusher plate 114 raised), the protrusion 540 (and the first sloped surface 542 and/or the second sloped surface 544) of the detent plunger 538 may be disposed in the notch 550 of the detent catch 548. The notch 550 and/or the first sloped catch surface 554 may engage the detent plunger 538. Engagement of the detent catch 548 and the detent plunger 536 may hold and/or retain the crusher device 100 (e.g., the crank 116 and the crusher plate 114) in its initial or starting position. The detent plunger 538 and/or the detent catch 548 may be configured such that the potential energy biasing the crusher device 100 to a final position (e.g., with the crank 116 drawn and the crusher plate 114 lowered) is insufficient to overcome the latching (e.g., retaining energy) of the detent plunger and detent catch 548. Thus, the latching system may retain the crusher device 100 in an initial or starting position.

As described, input force (e.g., from a user) on the crank 116 may be translated to the crusher plate 114 to move the crusher plate 114 downward (e.g., inferiorly). The input force may cause the first sloped catch surface 554 to engage the first sloped surface 542 of the detent plunger 538 and begin to deflect the detent plunger 538 (e.g., the protrusion 540) radially inward (e.g., into the scalloped region 546). With continued movement, the detent catch 548 may continue to radially deflect the detent plunger 538, for example, due to the engagement of the first sloped surface 542 and the first sloped catch surface 554. After the detent plunger 538 clears the notch 550, the pressing surface 552 of the detent catch 548 may engage the protrusion 540 and hold the protrusion 540 in a deflected position. At this point, the latch may be considered released and/or cleared, and the crusher device 100 may be moved to its final position substantially unobstructed by the latch system. With continued downward movement of the crusher plate 114 and bushing 532, the detent catch 548 may clear the detent plunger 538, and the detent plunger may return (e.g., radially outward) to its natural resting position.

Following the crushing movement, the crank 116 may be returned to its initial starting position (e.g., with the crank plate 114 raised), for example, with an input return force (e.g., from a user) to the crank 116. Upon return to the initial position, the detent catch 548 may engage the detent plunger 538. The return input force may cause the second sloped catch surface 556 to engage the second sloped surface 544 of the detent plunger 538. Engagement of the second sloped catch surface 556 with the second sloped surface 544 may begin to deflect the detent plunger 538 (e.g., the protrusion 540) (e.g., from its resting position) radially inward (e.g., into the scalloped region 546). With continued movement, and as a result of the engagement of the sloped surfaces, the detent catch 548 may continue to radially deflect the detent plunger 538 until the pressing surface 552 engages the detent plunger 538 protrusion 540. In this position, the pressing surface may hold the detent plunger 538 in a deflected (e.g., maximally deflected) position. With continued movement, the detent plunger 538 may clear the pressing surface 552 of the detent catch 548. With the pressing surface 552 cleared, the detent plunger 538 may return to its resting position. Return of the detent plunger 538 to its resting position may comprise the extension of the protrusion 540 into the notch 550. As described above, the detent plunger 538 engaged with the notch 550, may act as a latch to hold the crusher device 100 in its initial starting position.

As will be appreciated, the angles of incidence of the various sloped surfaces (e.g., first sloped surface 542, second sloped surface 544, first sloped catch surface 554, and second sloped catch surface 556) may be configured and adjusted to change, affect, and/or effect the holding force of the detent latch system, the amount of input force to overcome the detent latch system, and the return force to deflect the detent plunger 538. For example, the angle of incidence of the first sloped surface 542 may be increased to increase the holding force of the latch system or decreased to decrease the holding force of the latch system. Additionally it should be appreciated that in example configurations omitting the bushing 532, features of the detent catch 548 may be formed in the crusher plate 114. It should be appreciated that features of the present disclosure enable latching and holding of the crank 116 and crusher plate 114 with a single return motion. Additionally, features of the present disclosure enable unlatching and crushing of a beverage container with another single motion.

Additionally it may be appreciated that in other example configurations, the detent 536 may be otherwise shaped. For example, the detent 536 may comprise a partial circular shape. In such example configurations, the recess of the shaft 108 (e.g., receiving the detent plunger) may be other than annular (e.g., a partial circle). Additionally or alternatively, a detent plunger, for example, a detent ball, may be disposed in a hole in the shaft 108. The hole in the shaft may comprise a hole (e.g., about orthogonal to an axis of the shaft 108) extending through a portion of the shaft 108. In such an example configuration, the detent may comprise a linearly acting component and/or mechanism. The detent plunger (e.g., ball) may be spring loaded (e.g., by a spring disposed in the hole in the shaft 108), biasing the detent plunger radially outward. The spring-loaded detent plunger may retain the crusher device in an initial starting position. The spring-loaded detent plunger may be deflected and returned substantially as described herein in relation to the detent plunger 538.

Additional or alternative retention mechanisms are contemplated. For example, the crusher device may further comprise one or more gas struts or hydraulic pistons. The gas struts may be connected between the crusher plate 114 and the bottom plate 106. For example, the gas struts may replace the shafts 108. The gas struts may be naturally extended, and an input force may be used to compress the gas struts. Accordingly, in use, an input force to the crank 116 may apply an input force to the crusher plate 114 and a compression force to the gas struts. The gas struts may compress as the crusher plate 114 is moved downward. Following the crushing motion, the gas struts may apply an extension force (e.g., a restorative extension force) to the crusher plate 114. Thereby, the gas struts may return the crusher plate 114 to its starting or initial position. Additionally, the force of the gas strut may hold the crusher device in the extended position. Similarly, in an alternative configuration, a compression spring may be disposed around the shafts 108. The compression springs may operate substantially as described with respect to the gas struts. Accordingly, the spring may be compressed upon input force and downward movement of the crusher plate. Additionally, the restorative force of the spring may apply an upward force to the crusher plater 114, returning the crusher plate and the crank to a starting or initial position.

FIG. 6 depicts an example method 600 associated with a crusher device. The example method 600 may be associated with the operation of a crusher device. The example method 600 of FIG. 6 may be associated with the crusher device 100. One or more steps of the example method 600 may be omitted and/or conducted in a different order. The example method 600 may be conducted by a user.

At step 601 a container (e.g., container 326) may be seated (e.g., placed) (e.g., by a user) in a crusher device (e.g., crusher device 100). Seating the container in the crusher device may comprise seating the container in or on a portion of a frame (e.g., frame 102) of the crusher device. For example, the frame of the crusher device may comprise a bottom plate (e.g., bottom plate 106) and the container may be seated on the bottom plate. The crusher device may further comprise a crusher plate (e.g., crusher plate 114). The crusher plate may be configured to move (e.g., to slide, for example, substantially linearly) along a portion of the frame. For example, the crusher plate may be configured to move substantially vertically (e.g., upward and downward) along guides (e.g., shafts, for example, shafts 108) of the crusher device.

The crusher plate may comprise one or more ribs (e.g., container engagement ribs 430). The one or more ribs may extend from an underside of the crusher plate. The one or more ribs may be angled (e.g., inclined, ramped, sloped, etc.). The one or more ribs may be inclined downward from the underside of the crusher plate (e.g., inclined downward toward the bottom plate and rear of the frame (e.g., rear plate 104)) as the one or more ribs extend from a rear side to a front side of the crusher plate. The one or more ribs may be configured to engage a rim of the container, for example, if the crusher device is operated.

At step 603 an input force may be applied (e.g., by a user) to a crank (e.g., crank 116) of the crusher device. Applying the input force may comprise rotating the crank, for example, about a pivot point with the frame. The crank may be connected to the crusher plate such that the input force causes linear movement (e.g., vertical movement) of the crusher plate along the guides. Additionally, the crusher device may be configured to provide a mechanical advantage between the crank and the crusher plate. For example, the crusher device may be configured to increase (e.g., multiply) the input force between the crank and the crusher plate.

At step 605, a retaining detent mechanism (e.g., annular detent 536 and detent catch 548) may be disengaged (e.g., by a user). For example, prior to the input force (and subsequent sliding of the crusher plate), the crusher plate may be held in an initial position (e.g., a raised position), for example, by the retaining detent mechanism. The input force may be translated to a force on the crusher plate. The force on the crusher plate may cause disengagement of the detent mechanism. Accordingly, disengagement of the retaining detent mechanism may be based on the input force to the crank. Disengagement of the retaining detent mechanism may allow the crusher plate to move along the guides (e.g., with reduced obstruction).

At step 607, movement (e.g., sliding) of the crusher plate may be caused (e.g., by a user). For example, the sliding of the crusher plate may be based on the input force applied to the crank. The input force may be translated to a vertical force on the crusher plate. The vertical force on the crusher plate may cause vertical movement (e.g., downward) of the crusher plate, for example, along the guides. The vertical movement may comprise movement of the crusher plate in the direction of (e.g., towards) the bottom plate.

As described, it may be appreciated that the container may be substantially cylindrical and may comprise a central axis. At step 609, the rim of the container may be engaged, and/or a force may be applied to the rim of the container, at an angle to (e.g., other than perpendicular to, for example, non-perpendicular to) the central axis of the container. Additionally or alternatively, the crusher plate (e.g., via the inclined rib) may interface with the container (e.g., at a rim thereof) at an angle to the central axis of the container. For example, the one or more inclined ribs may comprise an interface with the container (e.g., the rim of the container). The one or more inclined ribs may interface the container in a non-perpendicular manner. Additionally or alternatively, the one or more inclined ribs may, upon initial engagement of the crusher plate with the rim of the container, initially engage a front portion of the rim of the container.

At step 611, a force may be applied to a rim of the container (e.g., caused by a user, for example, based on the input force to the crank). The force may comprise a vertical downward force and a horizontal force may be applied to the container. For example, as described, the crusher plate may comprise one or more inclined ribs. Upon movement of the crusher plate, the one or more inclined ribs may engage a rim of the container. The one or more inclined ribs may translate the input force to the crank to a vertical force component and a horizontal force component on the rim of the container.

It may be appreciated that step 609 and/or step 611 may provide one or more advantages. For example, containers (e.g., drink cans) may be designed to have increased strength in a direction of their central axis (e.g., to facilitate stacking). Accordingly, by creating an interface between the crusher plate and the rim of the container at an angle to the central axis of the container, and/or applying a force to the container rim at an angle (e.g., other than perpendicular) to the central axis of the container, the force may be applied at a more advantageous orientation for crushing the container. In this regard, the force to crush (e.g., buckle) the container, may be reduced. Additionally or alternatively, during crushing, the container may have a tendency to, at times, unseat and/or eject from the crusher device, by configuring an interface between the crusher plate and the rim of the container at an angle to the central axis of the container, and/or applying a force to the container rim at an angle to the central axis of the container, the interface and/or the force may act to retain the container in the device during the crushing. For example, as described, the angled interface (e.g., of the inclined ribs) may create a horizontal force component operable to hold the container in (e.g., prevent the ejection of the container from) the crusher device during operation.

At step 613, the user may continue to input force to and move the crank. The continued movement of the crank may cause continued downward movement of the crusher plate. The continued downward movement of the crusher plate may cause crushing of the container between the crusher plate and the bottom plate.

At step 615, the downward movement of the crusher plate may be interfered with. For example, the crusher plate may reach one or more end stops (e.g., bump stops 124). For example, one or more end stops may be disposed at an end of travel of the crusher plate. For example, the one or more end stops may be disposed around the guides at a top portion of the bottom plate. The one or more end stops may be configured to prevent the crusher plate from colliding with one or more other features of the crusher device. Additionally or alternatively, the one or more end stops may prevent the crank from colliding with one or more other features (e.g., the frame) of the crusher device. One or more of the foregoing features may prevent damage to the crusher device and provide for an extended working life of the crusher device.

At step 617, a return force may be applied to the crank (e.g., by the user). The crank may be moved from its end position toward its initial start position. The return force to the crank may cause the crusher plate to move vertically upward toward its initial position.

At step 619, the continued return force to the crank mechanism may cause engagement of the retaining detent mechanism. For example, as described, the return force to the crank may cause the vertical (e.g., upward) movement of the crusher plate. The vertical movement may cause one or more features of the crusher plate and/or one or more features engaged with the crusher plate, for example, a detent catch (e.g., detent catch 548) to engage a detent plunger (e.g., detent plunger 538). For example, as the crusher plate is moved upward, the detent catch may engage the detent plunger and cause the detent plunger to deflect away from a resting (e.g., equilibrium) position. With continued movement of the crusher plate, the detent plunger may clear one or more obstructions of the detent catch and the detent plunger may reform (e.g., return towards its resting position). The detent plunger may reform into the detent catch (e.g., of the crusher plate). Engagement of the detent plunger with the detent catch may operate to retain the crusher plate and/or the crank in the initial position.

One or more aspects of the present disclosure relate to a method comprising seating a container (e.g., container 326) in a frame (e.g., frame 102) of a container crusher device (e.g., crusher device 100). The container crusher device may comprise a plate (e.g., crusher plate 114) having one or more inclined ribs (e.g., vessel engagement ribs 430) configured to engage a rim of the container. The method may further comprise applying an input force to a crank (e.g., crank 116) of the crusher device. The method may further comprise disengaging, for example, based on the input force to the crank, a retaining detent mechanism (e.g., annular detent 536). The method may further comprise causing, for example, based on the input force to the crank and based on the one or more inclined ribs, a force to the rim of container at an angle to a central axis of the container. The method may further comprise crushing the container.

The present disclosure is disclosed above and in the accompanying drawings with reference to a variety of examples. The purpose served by the disclosure, however, is to provide examples of the various features and concepts related to the disclosure, not to limit the scope of the disclosure. One skilled in the relevant art will recognize that numerous variations and modifications may be made to the examples described above without departing from the scope of the present disclosure.

What is claimed is:

1. A container crusher comprising:
a frame configured to be fixed to a surface, the frame comprising a guide shaft;
a crank connected to the frame and configured to move about a pivot upon receipt of an input force;
a plate connected to the crank via a link such that rotation of the crank causes the plate to move linearly along the guide shaft;
an annular resilient detent plunger disposed in an annular recess of the guide shaft; and
a bushing engaged with the plate and the guide shaft, the bushing comprising an annular detent catch configured to engage the detent plunger to retain the crank and plate in raised positions.

2. The container crusher of claim 1, wherein the frame further comprises a platform substantially opposite the plate, and wherein the rotation of the crank causes the plate to move linearly toward the platform.

3. The container crusher of claim 1, wherein the plate, on an underside thereof, comprises one or more ribs, the one or more ribs being configured to engage an edge of a rim of a container upon the moving linearly of the plate.

4. The container crusher of claim 3, wherein each of the one or more ribs are inclined downward as the one or more ribs extend toward a front of the plate.

5. The container crusher of claim 1, wherein the plate, on an underside thereof, comprises one or more ribs configured to hold the container in the container crusher during operation.

6. The container crusher of claim 1, wherein the annular resilient detent plunger further comprises an annular protrusion configured to protrude from a surface of the guide shaft.

7. The container crusher of claim 6, wherein the annular protrusion comprises a first sloped surface and second sloped surface, the first and second sloped surface comprising different angles of inclination.

8. The container crusher of claim 6, wherein the annular protrusion is disposed at an outer surface of the annular resilient detent plunger, the annular resilient detent plunger further comprising an annular arcuate recess at an inner surface and substantially opposed to the annular protrusion.

9. The container crusher of claim 6, wherein the detent catch further comprises a notch configured to engage the annular protrusion to retain the crank and plate in a raised position.

10. The container crusher of claim 1, wherein the bushing further comprises a first sloped surface and a second sloped surface, the first sloped surface and the second sloped surface each configured to engage and deform the annular resilient detent plunger.

11. The container crusher of claim 1, wherein the plate comprises a hole, and wherein the bushing, in an outer surface thereof, further comprises a recess, wherein the hole and recess are configured to receive a screw, through the hole and into the recess, to retain the engagement of the bushing with the plate.

12. A container crusher comprising:
a frame comprising a platform;
a plurality of linear guide shafts fixed to the frame;
a crank connected to the frame at a pivot point, the crank configured to rotate about the pivot point;
a plate slidably mated, opposite the platform, to the plurality of linear guide shafts and connected, via one or more links, to the crank, such that the rotation of the crank causes the plate to linearly slide along the plurality of linear guide shafts;
a plurality of annular detent plungers, each disposed in an annular recess in each of the plurality of linear guide shafts; and
a plurality of bushings engaged with the plate and the plurality of linear guide shafts, each of the plurality of bushings comprising an annular detent catch configured to engage a corresponding annular detent plunger to retain the crank and the plate in substantially raised positions.

13. The container crusher of claim 12, wherein the plate, on an underside thereof, comprises a plurality of inclined ribs configured to engage an edge of a rim of a container and further configured to retain the container in the container crusher during use.

14. The container crusher of claim 12, wherein each of the plurality of annular detent plungers further comprise an annular projection configured to project from a surface of a corresponding one of the plurality of linear guide shafts.

15. A method comprising:
configuring a container crusher to comprise a guide shaft connected to a frame;
connecting a crank to the frame and configuring the crank to be rotated, about a pivot point on the frame, upon receipt of an input force;
connecting, via a link and to the crank, a plate, such that the rotation of the crank causes the plate to move linearly along the guide shaft;
disposing an annular resilient detent plunger in an annular recess of the guide shaft;
engaging a bushing with the plate and the guide shaft; and
configuring the bushing to include an annular detent catch for engaging the detent plunger and retaining the crank and plate in a raised position.

16. The method of claim 15, further comprising disposing, on an underside of the plate, one or more inclined ribs configured to engage a rim of a container.

17. The method of claim 16, further comprising configuring the one or more inclined ribs to, upon application of a force to the crank, hold the container in the container crusher.

18. The method of claim 15, further comprising configuring the annular resilient detent plunger to comprise a protrusion and an annular recess substantially opposite the protrusion.

19. The method of claim 18, further comprising configuring the annular resilient detent plunger to deform at least partially into the annular recess based on a force applied to the protrusion.

20. The method of claim 15, further comprising configuring the detent catch and the detent plunger such that an input force on the crank moves slides the detent catch against the detent plunger and deforms the detent plunger overcoming the retaining of the crank and the plate in the raised position.
